(19) United States
(12) Patent Application Publication
(10) Pub. No.: US 2004/0227712 A1
(43) Pub. Date: Nov. 18, 2004

(54) Image processing method, image processing apparatus, and liquid crystal display using same

(75) Inventors: Daigo Miyasaka, Tokyo (JP); Takashi Nose, Kanagawa (JP)

Correspondence Address: MCGINN & GIBB, PLLC, 8321 OLD COURTHOUSE ROAD, SUITE 200, VIENNA, VA, 22182-3817, US

(73) Assignees: NEC Corporation, Tokyo (JP); NEC Electronics Corporation, Kawasaki-shi (JP)

(21) Appl. No.: 10/835,398

(22) Filed: Apr. 30, 2004

(30) Foreign Application Priority Data
May 16, 2003 (JP) 139494/2003

(51) Int. Cl. G09G 3/36

(52) U.S. Cl. 345/89; 345/84

(57) ABSTRACT

A display, an image processing apparatus and an image processing method for producing excellent visual images while suppressing the accumulation of quantization errors related to increasingly complex digital image processing. Among a variety of image processing, processing which can be represented by look-up tables (LUT) such as constant number multiplication and constant number addition/subtraction is performed equivalently by changing reference values in a reference gray-level signal generator of a display. Thus, the operation of a digital image processing unit can be simplified, and there is obtained the display making the most use of the output dynamic range while suppressing the occurrence and accumulation of quantization errors.

### FIELD OF THE INVENTION

The present invention relates to an image processing method, an image processing apparatus and a liquid crystal display (LCD) using the same, and more particularly, to an image processing apparatus provided with a digital image signal processing circuit.

### BACKGROUND OF THE INVENTION

It is often the case that display units such as an LCD are provided with a circuit to carry out image processing for input image signals as usage. For example, such circuit performs image processing for reproducing colors precisely among different video units and for showing broadcast images or movies more desirably.

In recent years, as the operating frequency range for LSI has been extended and its price has been reduced, there is a growing tendency to perform the image processing digitally. Besides, with the progress in the shrinkage of transistors, it becomes possible to implement complicated image processing which requires more calculations or operations at reasonable cost.

In the LCD, output signals from the digital image processing circuit are converted into analog voltages by a digital-to-analog converter (DAC), and the voltages are applied to pixels to display an image. The applied voltages determine the brightness or intensity of respective pixels. The applied voltages are controlled to realize multiple tone display.

FIG. 1(a) is a chart showing an example of the voltage (voltages applied to pixels)—intensity characteristic of a normally white-type liquid crystal panel in which an applied voltage of zero is assigned to the maximum intensity. FIG. 1(b) is a chart showing an example of the gray level—intensity characteristic (gamma characteristic). While the normally white-type liquid crystal panel is taken as an example in the following description, the same may be said of a normally black-type liquid crystal panel in which an applied voltage of zero is assigned to the minimum intensity. The LCD converts digital image signals into analog voltages by which desired intensity can be obtained through the DAC according to characteristics shown in FIGS. 1(a) and 1(b) to display an image on an LCD screen.

Such image processing as to enhance the amplitude of image signals is generally performed in order that a clearer image may be displayed. With this image processing, the contrast of an input image is enhanced, and optical sharpness in a display image is improved.

The aforementioned image processing to enhance the amplitude of image signals, however, may cause pseudo outlines (lines which should not be actually seen in gradation parts) and make noise or interference prominent. In the conventional LCD, this problem is created at an image processing unit or the DAC, and particularly acute when a dark image is input.

Normally, 8-bit digital signals (indicating values between 0 and 255) are input to the image processing unit. In the gradation part, the values of adjacent pixels differ from one another by 1, as for example 8, 9, 10, 11, . . . . A difference of 1 in pixel value causes no visually perceptible color distinction. However, if the amplitude of image signals corresponding to the gradation part is enhanced, the difference, which is supposed to be 1, is widened. Consequently, visible color distinctions are produced as pseudo outlines.

In addition, noise in the dark part of an image, which cannot be seen when the dark part differs from the periphery thereof by only 1 in pixel value, becomes recognizable if the difference is widened due to amplitude enhancement.

A quantization error, which occurs on the occasion of calculation, is incriminated as one of the causes of this problem. Especially, when gray levels are low, the quantization error produces a great effect.

Besides, when an input signal is subject to gamma correction, image processing such as amplitude enhancement has to be performed after the signal is converted into an intensity level (inverse gamma correction). In the conversion, if the gamma value of an input image is, for example, 2.2, the following calculation is carried out:

intensity level=maximum intensity×(input gray level/maximum gray level)^{2.2}.

According to this calculation, bit accuracy deteriorates especially in the case of dark gray levels. Consequently, problems such as gray-level distortion arise. Additionally, the quantization error is more likely to cause unnatural pseudo outlines and noise. Such problems become increasingly prominent as image processing becomes more complicated, and the quantization error accumulates as steps in the process increase. Thus, pseudo outlines, noise and the like become easily recognizable.

One approach to these problems is to increase the number of bits of a digital signal. This approach, however, results in an increase in the size or scale of gates for operations and therefore has a limitation from the aspect of cost.

The DAC generally carries out the conversion which is uniquely determined by the gamma characteristic of an input image and the voltage—intensity characteristic of the LCD so as to output a voltage value in fixed or one-to-one relation to an input digital signal. It is the same whether or not image processing has been performed at former stages.

Further, an 8-bit signal is commonly input to the DAC. This indicates that accuracy in the gray levels of a dark image is eventually determined by the quantization width of the DAC even if image processing performed when the dark image is input is improved (that is, the number of bits is increased).

As a conventional technique that substantially solves the problem with the fixed relation between an input digital signal and an output voltage value, there is disclosed “Liquid Crystal Display and Driving Method Thereof” in Japanese Patent Application laid open No. 2002-333863. According to the conventional technique, a voltage—intensity characteristic with respect to each color component (red, blue and green) is independently generated, and a reference gray-level voltage is changed based on the gamma characteristic. Thereby, it is possible to suppress a reduction in the number of gray levels of an output image, and prevent a deterioration in image quality.

The conventional technique, however, has no regard to the quantization error involved in digital image processing. Therefore, the increase of the quantization errors resulting from complicated digital image processing and an increase of steps in the process cannot be prevented through the direct application of the conventional technique.

### SUMMARY OF THE INVENTION

It is therefore an object of the present invention to provide an image processing method, an image processing apparatus and a liquid crystal display (LCD) which realize visually excellent display without cost increase while suppressing enlargement of the gate size or scale of an image processing unit.

In accordance with the first aspect of the present invention, to achieve the above object, there is provided an LCD comprising: an LCD screen for displaying an image based on input image signals, a gray-level corrector for generating and outputting an analog gray-level voltage based on respective digital image signals so that an image according to the digital image signals is displayed on the LCD screen, and a digital image processing unit for carrying out predetermined arithmetic operations for the digital image signals, wherein prescribed image processing is performed for the digital image signals by changing corrective characteristics of the gray-level corrector.

With this construction, it is possible to obtain a display using the output dynamic range to the greatest extent possible, in which the arithmetic operations performed by the digital image processing unit are simplified, and also the accumulation of quantization errors is suppressed.

Preferably, in the first aspect, the prescribed image processing is processing which can be represented as look-up tables, and each color component of a digital image signal before and after the processing is presented in the look-up table for the color component. Alternatively, the prescribed image processing may be processing which can be represented by a combination of constant number multiplication, constant number addition and subtraction, and S-curve correction.

In accordance with the second aspect of the present invention, there is provided an LCD comprising: an LCD screen for displaying an image based on input image signals, a gray-level corrector for generating and outputting an analog gray-level voltage based on respective digital image signals so that an image according to the digital image signals is displayed on the LCD screen, a digital image processing unit for carrying out predetermined arithmetic operations for the digital image signals, and a correction parameter generator for generating correction parameters used for the arithmetic operations by the digital image processing unit, wherein the correction parameter generator feeds the gray-level corrector with the correction parameters so that prescribed image processing is to be performed based in the parameters.

Preferably, in the second aspect of the present invention, the prescribed image processing is processing which can be represented as look-up tables, and each color component of a digital image signal before and after the processing is presented in the look-up table for the color component. Alternatively, the prescribed image processing may be processing which can be represented by a combination of constant number multiplication, constant number addition and subtraction, and S-curve correction.

In accordance with the third aspect of the present invention, there is provided an LCD comprising: an LCD screen for displaying an image based on input image signals, a gray-level corrector for generating and outputting an analog gray-level voltage based on respective digital image signals so that an image according to the digital image signals is displayed on the LCD screen, a digital image processing unit for carrying out predetermined arithmetic operations for the digital image signals, and a correction parameter generator for generating correction parameters used for the arithmetic operations by the digital image processing unit, wherein the correction parameter generator feeds the gray-level corrector with the generated correction parameters.

Preferably, in the second and third aspects of the present invention, the correction parameter generator determines the correction parameter based on input digital image signals. Alternatively, the correction parameter generator may determine the correction parameter based on a histogram for the input digital image signals of one frame.

In both the second and third aspects of the present invention, it is desirable that the correction parameter generator should generate the correction parameter in the case where an image according to the digital image signals changes more than a specific quantity.

In all of the first, second and third aspects of the present invention, it is desirable that the gray-level corrector should include a first digital-to-analog converter (DAC) for converting the digital image signal into an analog voltage and a reference gray-level voltage generator for setting a gray-level characteristic based on the relation between the input voltage and display intensity of the LCD screen, and the reference gray-level voltage should be changed based on the correction parameter. It is further desirable that the reference gray-level voltage generator should include a second DAC having the same gray-level characteristic as that of the first DAC. Alternatively, the reference gray-level voltage generator may include a means for selecting the reference gray-level voltage based on the correction parameter.

In accordance with the fourth aspect of the present invention, there is provided an image processing apparatus comprising: a digital image processing unit for carrying out predetermined arithmetic operations for digital image signals and an image signal converter for converting the digital image signal which has undergone the arithmetic operation into a signal used to apply a voltage to a pixel of an LCD screen, wherein prescribed image processing is performed for the digital image signals by changing signal conversion characteristics of the image signal converter.

In accordance with the fifth aspect of the present invention, there is provided an image processing apparatus comprising: a digital image processing unit for carrying out predetermined arithmetic operations for digital image signals; an image signal converter for converting the digital image signal which has undergone the arithmetic operation into a signal used to apply a voltage to a pixel of an LCD screen; and a correction parameter generator for generating correction parameters used for the arithmetic operations by the digital image processing unit, wherein the correction parameter generator feeds the image signal converter with the generated correction parameters.

In accordance with the sixth aspect of the present invention, there is provided an image processing apparatus comprising: a digital image processing unit for carrying out predetermined arithmetic operations for digital image signals; an image signal converter for converting the digital image signal which has undergone the arithmetic operation into a signal used to apply a voltage to a pixel of an LCD screen; and a correction parameter generator for generating correction parameters used for the arithmetic operations by the digital image processing unit, wherein the correction parameter generator feeds the image signal converter with the correction parameters so that prescribed image processing is to be performed.

Preferably, in the fifth and sixth aspects of the present invention, the correction parameter generator determines the correction parameter based on input digital image signals. Alternatively, the correction parameter generator may determine the correction parameter based on a histogram for the input digital image signals of one frame.

In both the fifth and sixth aspects of the present invention, it is desirable that the correction parameter generator should generate the correction parameter in the case where an image according to the digital image signals changes more than a specific quantity.

In accordance with the seventh aspect of the present invention, there is provided an image processing method comprising a correction parameter generating step for generating a calculation parameter and a step for carrying out a predetermined arithmetic operation for each digital image signal by the use of the calculation parameter, wherein a correction parameter for prescribed image processing is generated at the correction parameter generating step.

### BRIEF DESCRIPTION OF THE DRAWINGS

The objects and features of the present invention will become more apparent from the consideration of the following detailed description taken in conjunction with the accompanying drawings in which:

FIG. 1(a) is a chart showing an example of the voltage (voltage applied to respective pixels of an LCD screen)—intensity characteristic;

FIG. 1(b) is a chart showing an example of the image signal—intensity characteristic (gamma characteristic);

FIG. 2 is an explanatory diagram showing an LCD having an image processing step and a gray-level signal generating step;

FIG. 3 is a chart showing the relation between inputs/outputs of a DAC and outputs from a reference gray-level signal generator;

FIG. 4 is a block diagram showing the construction of an LCD according to the first embodiment of the present invention;

FIG. 5 is a block diagram showing an example of the construction of a reference gray-level signal generator according to the first embodiment of the present invention;

FIG. 6 is a block diagram showing the construction of an LCD according to the second embodiment of the present invention;

FIG. 7 is a block diagram showing an example of the construction of a reference gray-level signal generator according to the second embodiment of the present invention;

FIG. 8 is a block diagram showing the construction of an LCD according to the third embodiment of the present invention;

FIG. 9 is a block diagram showing the construction of a conventional LCD performing the same process as an image processing function of the LCD according to the third embodiment of the present invention;

FIG. 10 is a block diagram showing an example of the construction of a reference gray-level signal generator according to the third embodiment of the present invention;

FIG. 11 is a block diagram showing another example of the construction of a reference gray-level signal generator according to the third embodiment of the present invention;

FIG. 12 is a block diagram showing the construction of an LCD according to the fourth embodiment of the present invention;

FIG. 13 is a block diagram showing an example of the construction of a reference gray-level signal generator according to the fourth embodiment of the present invention;

FIG. 14 is a block diagram showing the construction of an LCD according to the fifth embodiment of the present invention;

FIG. 15 is a diagram showing a construction for setting a contrast correction value;

FIG. 16 is a diagram showing the relation between changes in screen image and contrast correction quantity;

FIG. 17 is a block diagram showing the construction of an image processing apparatus according to the sixth embodiment of the present invention; and

FIG. 18 is a diagram showing functional blocks implemented on a computer by software for carrying out image processing according to the seventh embodiment of the present invention.

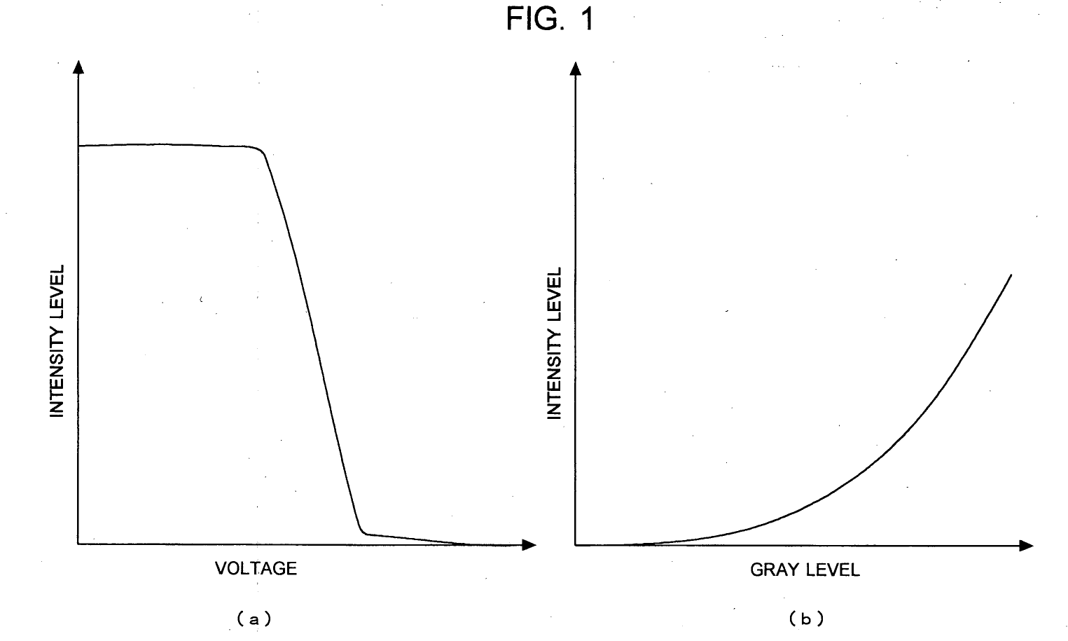

### DESCRIPTION OF THE PREFERRED EMBODIMENTS

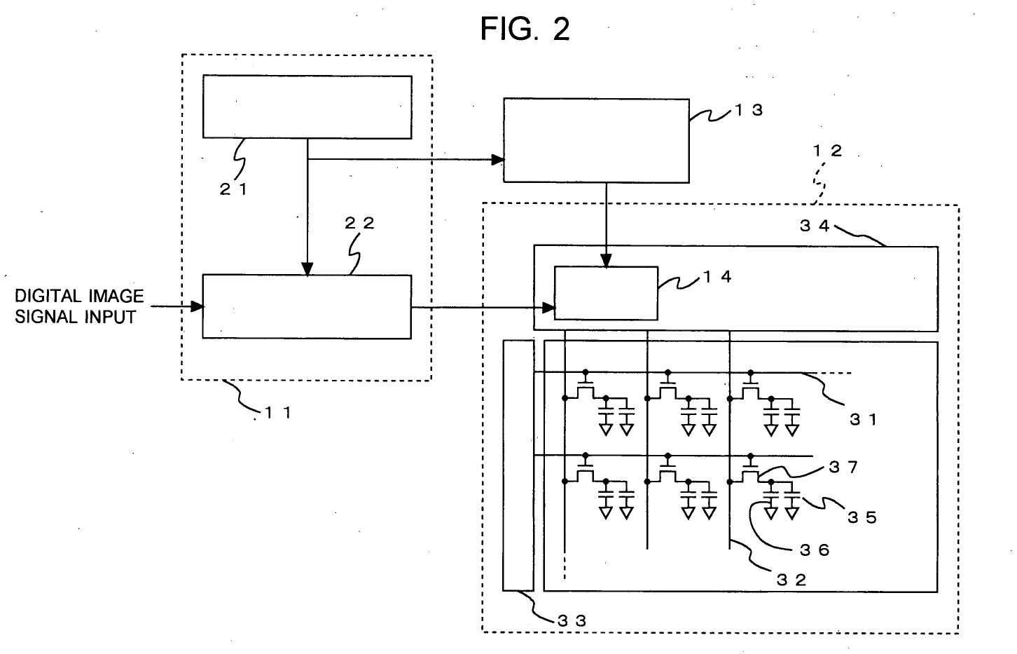

In the following, the principle and function of the present invention will be described. FIG. 2 is a block diagram showing an example of the construction of a liquid crystal display (LCD) according to the present invention. With reference to FIG. 2, a description will be given of the LCD which performs an image processing step and a gray-level signal generating step.

As can be seen in FIG. 2, the LCD comprises an image processing unit 11, an LCD screen 12 and a reference gray-level signal generator 13. The image processing unit 11 includes a correction parameter generator 21 for determining the quantity of correction in image processing and a digital image processing unit 22 for carrying out calculations or operations for input digital image signals based on the correction quantity. The LCD screen 12 includes at least a plurality of scanning lines 31, a plurality of signal lines 32, a scanning line driver 33 for controlling signals input to the scanning lines 31, a signal line driver 34 for controlling signals input to the signal lines 32, a matrix of pixels 35, auxiliary capacitors 36 each being connected in parallel with each pixel 35, and thin film transistors (TFT) 37. The scanning lines 31 running in a horizontal direction and the signal lines 32 running in a vertical direction are intersected with each other. Each of the pixels 35 is set at the intersection of each scanning line 31 and signal line 32 through the TFT 37.

The signal line driver 34 includes a digital-to-analog converter (DAC) 14 for carrying out digital/analog conversion on the basis of a conversion characteristic obtained from the applied voltage—intensity characteristic of the respective pixels 35 of the LCD screen 12 and the gamma characteristic of an input image signal.

Incidentally, the DAC 14 is not necessarily set in the signal line driver 34 so long as it is placed in between a stage subsequent to the image processing unit 11 and the pixels 35.

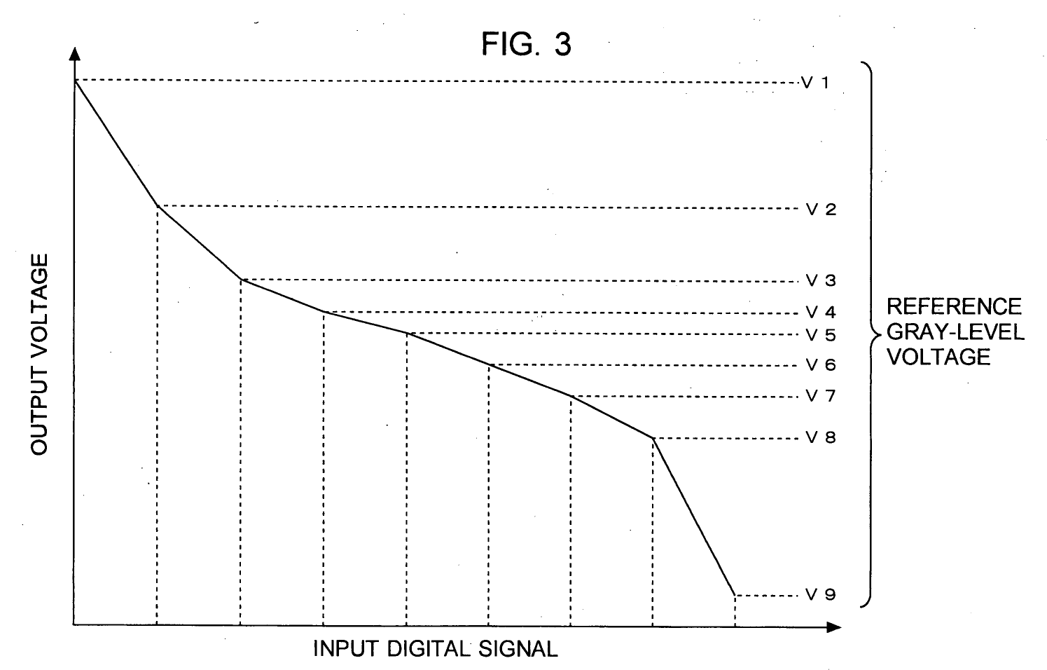

The reference gray-level signal generator 13 outputs plural kinds of voltages as reference voltages for conversion made by the DAC 14. FIG. 3 is a chart showing the relation between inputs/outputs from the DAC 14 and output voltages from the reference gray-level signal generator 13. In FIG. 3, reference gray-level voltages V1 to V9 each provide a voltage at a specific gray level, and voltages at other gray levels are determined by resistance partial voltage (potential). That is, voltages output from the DAC 14 after conversion are determined by the outputs of the reference gray-level signal generator 13.

In the following, a description will be given of the operation of the LCD from when digital image signals are input to when an image is displayed on the LCD screen 12. First, the image processing unit 11 carries out calculations for the input digital image signals, and outputs the digital signals. The DAC 14 makes the D/A conversion of each digital signal according to a conversion characteristic obtained from the applied voltage—intensity characteristic of the respective pixels 35 of the LCD screen 12 and the gamma characteristic of the input image signal. In order to provide the DAC 14 with the conversion characteristic, the reference gray-level signal generator 13 generates plural reference gray-level voltages, and outputs them to the DAC 14. The signals which have been converted to analog voltages are applied to the pixels 35 via the TFTs 37 and converted into brightness or intensity. Thus, an image is displayed on the LCD screen 12.

As has been described above, pseudo outlines and noise are generated as steps in the process by the image processing unit 11 increase. Besides, quantization errors in the DAC 14 also cause pseudo outlines and noise, especially in an image with low contrast since the reference gray-level signal generator 13 outputs fixed voltages. That is, in order to suppress the generation of pseudo outlines and noise, it is preferable not to perform digital calculations as much as possible in the image processing unit 11. If the DAC 14 carries out processing that is equivalent to the digital calculations unperformed by the image processing unit 11, the generation of pseudo outlines and noise can be suppressed. This requires a construction in which the output of the correction parameter generator 21 is sent to the reference gray-level signal generator 13.

As a concrete example of image processing, processing for doubling the amplitude (intensity) of image signals will be described with reference to FIG. 2. In this case, in a conventional construction, the image processing unit 11 performs digital image processing. Through the processing, an inverse gamma correction is made for flattening a gray level—intensity characteristic, the amplitude of each signal which has undergone the correction is doubled, and after that, a gamma correction is performed again.

On the other hand, according to the present invention, the image processing unit 11 does not perform such processing and input signals are directly output therefrom as output signals. Having received an instruction to “double intensity” from the correction parameter generator 21, the reference gray-level signal generator 13 generates a reference voltage such that the intensity of each input signal is doubled, and outputs the voltage to the DAC 14. By virtue of this construction, amplitude enhancement processing can be performed while preventing the image processing unit 11 from causing pseudo outlines and noise.

When the amplitude of image signals is changed to one-half times the original, another effect is produced. In the following this will be described. In the conventional construction, the image processing unit 11 executes image processing for halving the amplitude of image signals by truncating the least significant bit of each input digital image signal (bit dropping). However, the bit dropping may cause gray-level distortion.

On the other hand, according to the present invention, the reference gray-level signal generator 13 changes the reference voltage as in the processing for doubling the amplitude of image signals. Thereby, it is possible to reproduce smooth shades or gradations without causing gray-level distortion due to the bit dropping.

Processing, which is equivalent to the digital calculations and implemented in the DAC 14, is not restricted to the amplitude enhancement described above by way of example. As the processing in the DAC 14 can be said to be substantially similar to the look-up operation, processing, which is performed highly efficiently by changing reference voltages in the reference gray-level signal generator 13, can be represented by look-up tables (LUT). Examples of such processing include constant number multiplication and constant number addition, and, in terms of processing content, contrast/brightness correction, S-curve correction and white balance collection.

However, when there is a branch or a conditional branch in image processing, or when the addition of a variable is performed among R, G and B signals, processing in the DAC 14 is complicated, if not impossible, and the size or scale of gates of the DAC 14 is increased.

Therefore, by deciding whether to perform image processing in the digital image processing unit 22 or the DAC 14 based on the presence or absence of the branch or conditional branch, the image processing can be carried out under optimum conditions.

Referring now to the drawings, a description of preferred embodiments of the present invention will be given in detail based on the above-described principle of the present invention.

For the sake of simplicity a gamma correction value will be 1, that is, the gray level and intensity level will be in a linear relation to each other in the following embodiments. However, the present invention is applicable if the gamma correction value is not 1 with the same advantages. Incidentally, like reference numerals refer to corresponding parts throughout the drawings.

First Embodiment

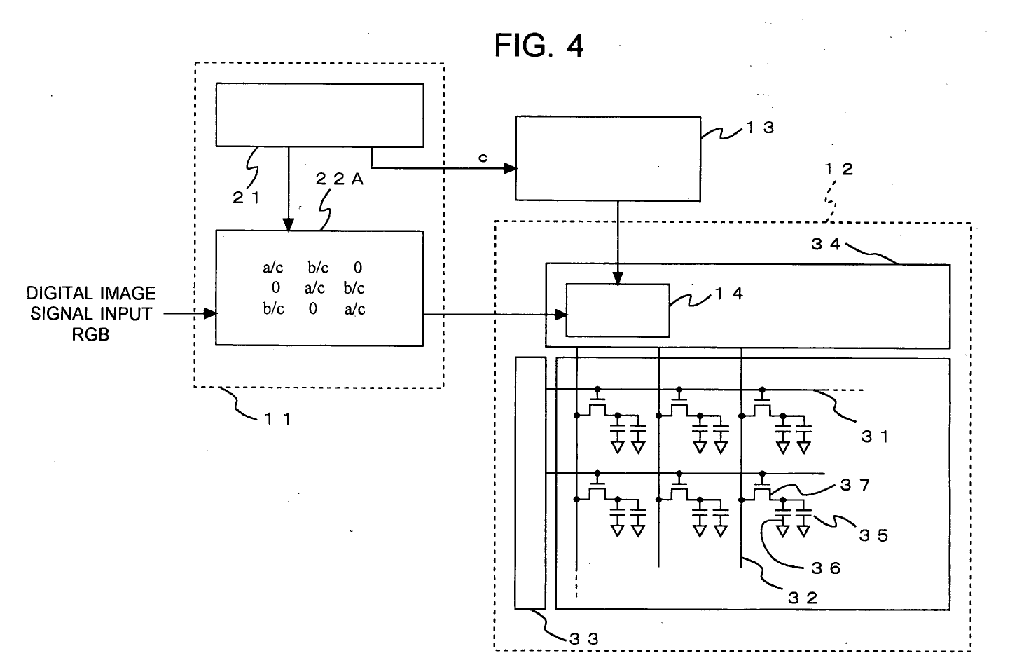

FIG. 4 is a block diagram showing the construction of an LCD according to the first embodiment of the present invention. With reference to FIG. 4, a description will be made of the first embodiment of the present invention.

As can be seen in FIG. 4, the LCD comprises an image processing unit 11, an LCD screen 12 and a reference gray-level signal generator 13. The LCD performs a 3×3 matrix operation with respect to 8-bit image signals for three primary colors R, G, and B input to the image processing unit 11.

The image processing unit 11 includes a correction parameter generator 21 and a 3×3 matrix converter 22A.

The LCD screen 12 includes at least a plurality of scanning lines 31, a plurality of signal lines 32, a scanning line driver 33 for controlling signals input to the scanning lines 31, a signal line driver 34 for controlling signals input to the signal lines 32, a matrix of pixels 35, auxiliary capacitors 36 each being connected in parallel with each pixel 35, and thin film transistors (TFT) 37. The scanning lines 31 running in a horizontal direction and the signal lines 32 running in a vertical direction are intersected with each other. Each of the pixels 35 is set at the intersection of each scanning line 31 and signal line 32 through the TFT 37. The signal line driver 34 includes a digital-to-analog converter (DAC) 14.

The image processing unit 11 includes a correction parameter generator 21 and a 3×3 matrix converter 22A. The correction parameter generator 21 produces a correction parameter for the matrix operation. The 3×3 matrix converter 22A carries out the matrix operation for digital signals. The digital signals which have undergone the matrix operation are input to the LCD screen 12, and converted into analog voltages by the DAC 14. The values of analog voltages are determined based on reference voltages provided by the reference gray-level signal generator 13 as described previously in connection with FIG. 2. The signals which have been converted into analog voltages are applied to the pixels 35, respectively, through the signal line driver 34 and each of the TFTs 37, and converted into brightness or intensity. Thus, the digital signals are output as an image.

When 8-bit digital signals for colors R, G, and B are input as image signals, the 3×3 matrix converter 22A carries out the matrix operation for the R, G and B digital signals as processing by the digital image processing unit. The matrix operation is expressed as follows:

Rout=a11×Rin+a12×Gin+a13×Bin

Gout=a21×Rin+a22×Gin+a23×Bin

Bout=a31×Rin+a32×Gin+a33×Bin

where Xin (X=R, G, B) is an input digital signal with one of values between 0 and 255, Xout is an output digital signal, and axy (x, y=1, 2, 3) is a correction parameter. Xout is of an 8-bit value as with the input signal, and also the correction parameter is of an 8-bit value. To be specific, the matrix operation is performed for the color-space conversion of an RGB image.

With regard to the parameters in the matrix, it is assumed that a11=a22=a33=A, a12=a23=a31=B, and a13=a21=a32=0 (A+B=C, C<1). In this case, the maximum value of results of the matrix operation is 255×C, and therefore, all the parameter values sent to the 3×3 matrix converter 22A are multiplied by 1/C so that the value (255×C) is to be the maximum value which can be represented by the output digital signal, 255. Besides, the correction parameter generator 21 sends the reference gray-level signal generator 13 a parameter such that multiplication by C is to be performed. Consequently, correction parameters sent from the correction parameter generator 21 to the 3×3 matrix converter 22A become a11=a22=a33=A/C, a12=a23=a31=B/C, and a13=a21=a32=0. Thus, it is possible to make maximum use of the dynamic range when the 3×3 matrix converter 22A carries out the matrix operation, and operation accuracy can be improved.

In addition, the reference gray-level signal generator 13 generates reference voltages such that the intensity levels of input signals are to be multiplied by C, and outputs the voltages to the DAC 14. Thereby, the equivalent of processing in the image processing unit 11 for multiplying digital image signal input by C is performed, and desired outputs can be obtained.

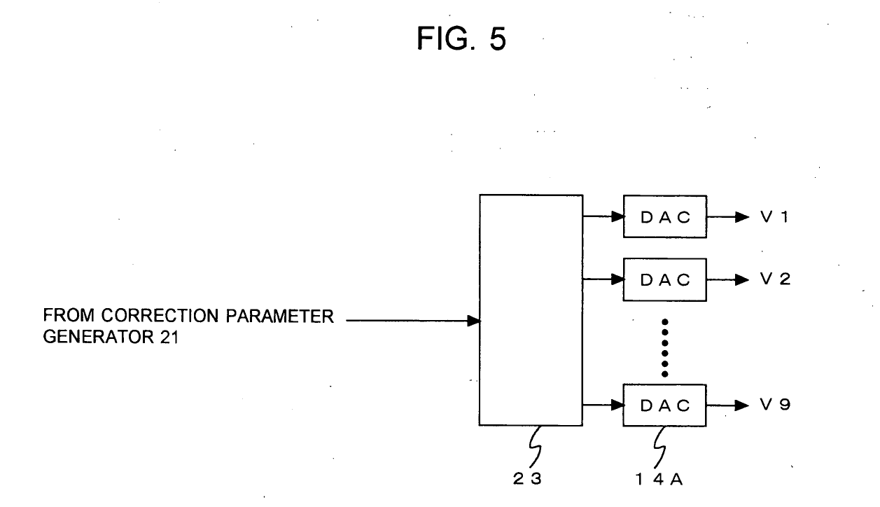

FIG. 5 is a block diagram showing an example of the construction of the reference gray-level signal generator 13 according to the first embodiment of the present invention. In FIG. 5, the reference gray-level signal generator 13 includes a plurality of DACs 14A and a digital signal generator 23. The digital signal generator 23 sends the DACs 14A digital signals corresponding to reference gray-level voltages V1 to V9 to be sent to the DAC 14 based on a signal “C” received from the correction parameter generator 21. The DACs 14A output desired analog voltages based on the signals sent from the digital signal generator 23. In this manner, desired reference gray-level voltages can be generated in response to an arbitrary conversion signal from the correction parameter generator 21.

As described above, processing which can be represented by LUTs is performed by changing reference voltages in the reference gray-level signal generator 13, and other processing is performed in the digital image processing unit 22. Thus, it is possible to minimize quantization errors and to suppress the generation of pseudo outlines and noise.

Second Embodiment

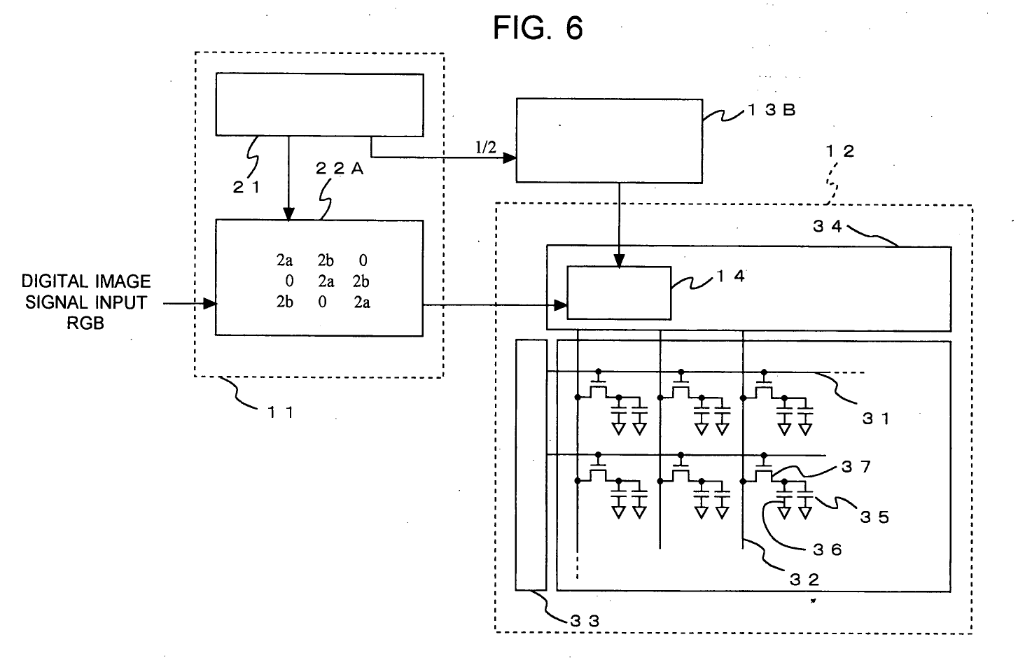

FIG. 6 is a block diagram showing the construction of an LCD according to the second embodiment of the present invention. As can be seen in FIG. 6, the LCD of the second embodiment has essentially the same construction as that in the first embodiment except for a reference gray-level signal generator 13B. In this embodiment, signals sent to the digital image processing unit 22 are multiplied by ½ and signals sent to the reference gray-level signal generator 13 are multiplied by 2, while they are multiplied by 1/C and C, respectively, in the first embodiment.

When 8-bit digital signals for colors R, G, and B are input as image signals, the 3×3 matrix converter 22A carries out the matrix operation for the R, G and B digital signals as processing by the digital image processing unit. In this case, matrix elements axy become a11=a22=a33=A/2, a12=a23=a31=B/2, and a13=a21=a32=0.

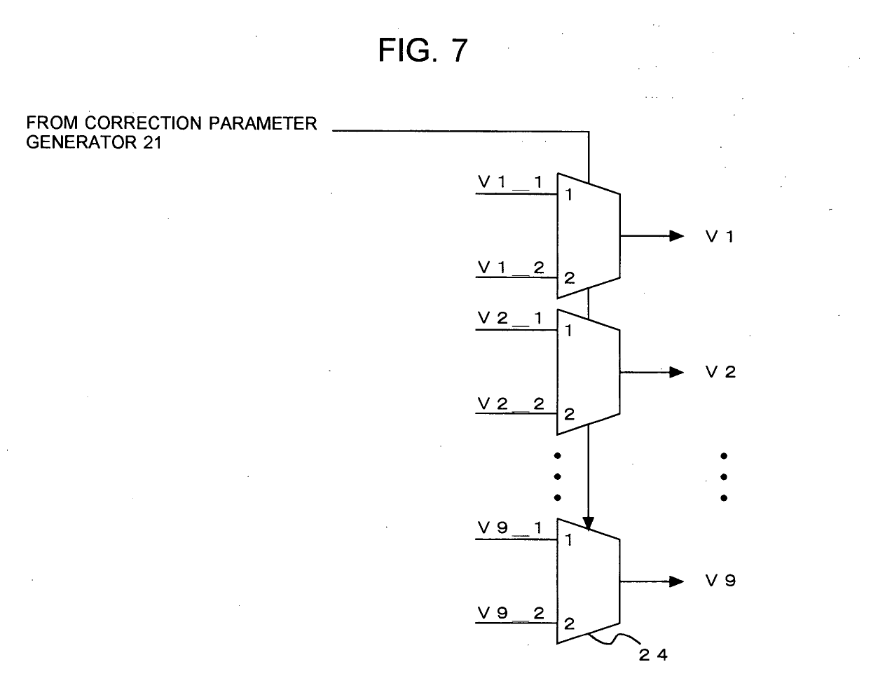

Next, the reference gray-level signal generator 13B will be described. FIG. 7 is a block diagram showing an example of the construction of the reference gray-level signal generator 13B. The reference gray-level signal generator 13B includes a plurality of selectors 24. The reference gray-level signal generator 13B selects output signals by the selectors 24 based on whether a signal output from the correction parameter generator 21 indicates 1 (no image processing is to be performed) or 2 (intensity level is to be doubled), and outputs the selected signals to the DAC 14. On this occasion, the selectors 24 determine whether the correction parameter is 1 or 2 depending on matrix parameters. More specifically, in the case where the maximum value of output signals after the matrix operation is 255×½ or less, respective matrix parameters are doubled, and a signal selected by each of the selectors 24 indicates “2”. On the other hand, in the case where the maximum value of output signals after the matrix operation is larger than 255×½, the matrix parameters are left unchanged, and a signal selected by each of the selectors 24 indicates “1”.

With this construction, reference gray-level voltages can be selected more easily although there is less latitude regarding output signals from the correction parameter generator 21.

A description has been given of an example of construction in which one of respective pairs of reference gray-level voltages is selected. However, there may be prepared numbers of reference gray-level voltages so that a selection can be made from more reference gray-level voltages with the use of multiinput (3 or more input) selectors as selectors 24.

Third Embodiment

In the aforementioned first and second embodiments, only the 3×3 matrix operation is carried out as image processing for input signals. In this embodiment, meanwhile, the 3×3 matrix operation is carried out in parallel with contrast correction.

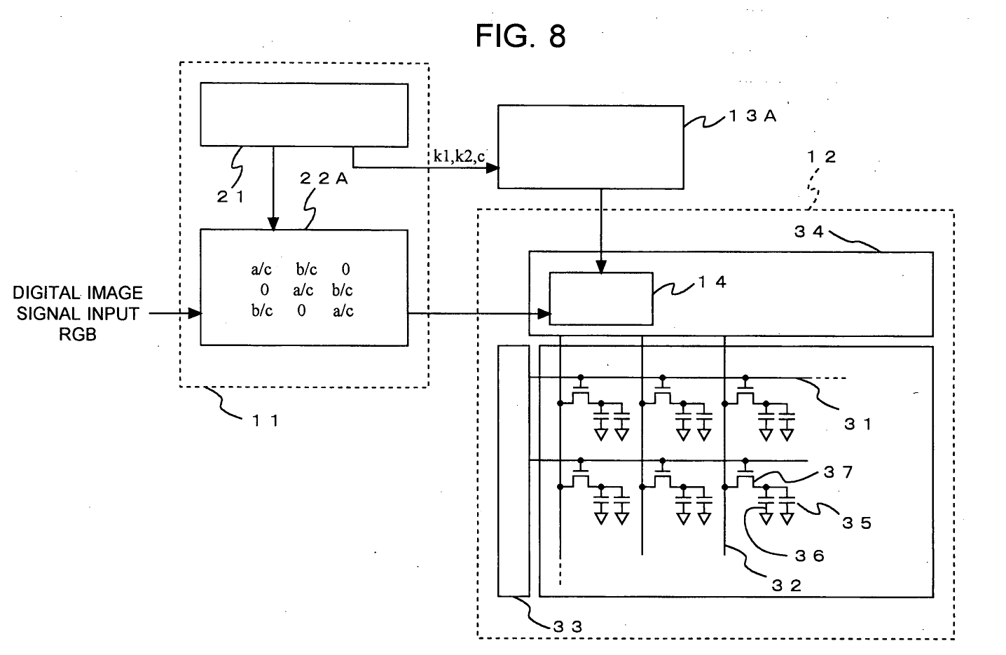

FIG. 8 is a block diagram showing the construction of an LCD according to the third embodiment of the present invention. As can be seen in FIG. 8, the LCD of the third embodiment has essentially the same construction as that in the first embodiment except for a reference gray-level signal generator 13A. In this embodiment, the correction parameter generator 21 sends contrast correction parameters to the reference gray-level signal generator 13A.

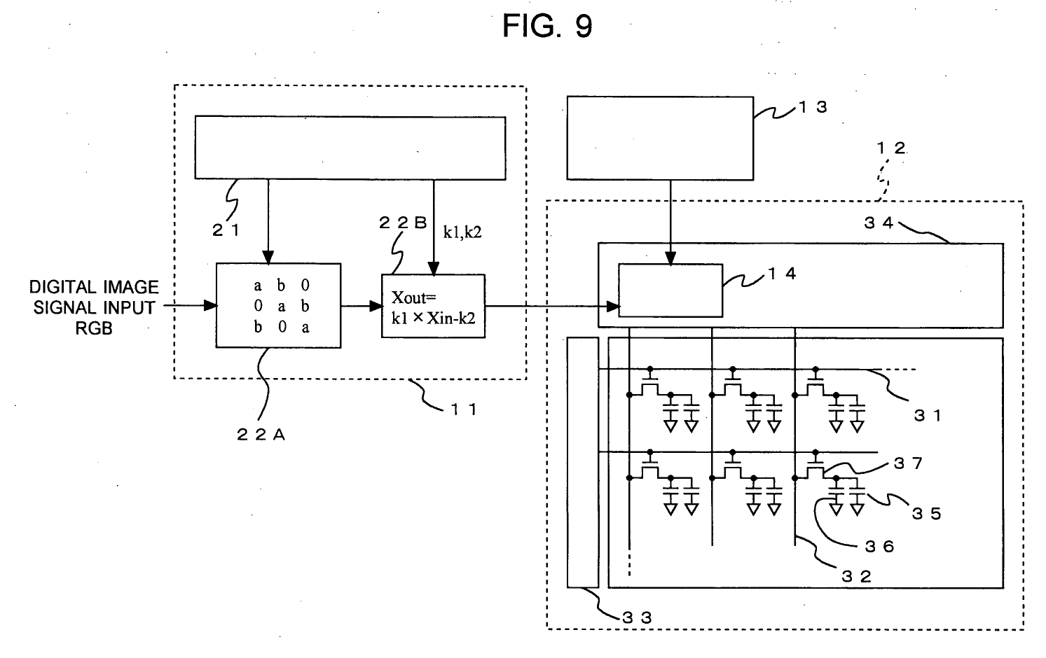

FIG. 9 is a block diagram showing the construction of a conventional LCD in which the image processing unit 11 performs the 3×3 matrix operation and contrast correction. A comparison of FIG. 8 with FIG. 9 indicates that the correction parameter generator 21 sends parameters to the reference gray-level signal generator 13 in the LCD of this embodiment, while no correction parameter is sent to the generator 13 in the conventional LCD. Additionally, contrast correction is made by the reference gray-level signal generator 13 in the LCD of the third embodiment, while it is made by a contrast corrector 22B provided to the image processing unit 11 in the conventional LCD.

In the following, the LCD of the third embodiment of the present invention will be described in comparison with the conventional LCD shown in FIG. 9.

The 3×3 matrix converter 22A of the conventional LCD carries out a matrix operation as follows:

Rout′=a11×Rin+a12×Gin+a13×Bin

Gout′=a21×Rin+a22×Gin+a23×Bin

Bout′=a31×Rin+a32×Gin+a33×Bin

where a11=a22=a33=A, a12=a23=a31=B, and a13=a21=a32=0 (A+B=C, C<1).

Besides, having received digital signals output from the 3×3 matrix converter 22A, the contrast corrector 22B performs an operation as follows:

Rout=k1×Rout′−k2

Gout=k1×Gout′−k2

Bout=k1×Bout′−k2

where k1 and k2 are parameters obtained from the correction parameter generator 21.

Due to such correction, quantization errors are accumulated each time the operation is performed. Consequently, unnatural pseudo outlines and noise are more likely to be produced. In addition, when the minimum value of output digital signal values (Xout: 8 bits) obtained through the contrast correction and matrix conversion is larger than 0 and the maximum value is smaller than 255, the dynamic range of the DAC 14 at the latter stage is not fully used. Therefore, quantization errors become more prominent.

With this in view, the reference gray-level signal generator 13A of the third embodiment is provided with the function of the contrast corrector 22B in the conventional LCD shown in FIG. 9.

The 3×3 matrix converter 22A carries out operations using parameters, a11=a22=a33=A/C, a12=a23=a31=B/C, and a13=a21

=a32=0, as in the first embodiment. By virtue of this construction, accumulative quantization errors can be reduced since the image processing unit 11 performs only the matrix conversion.

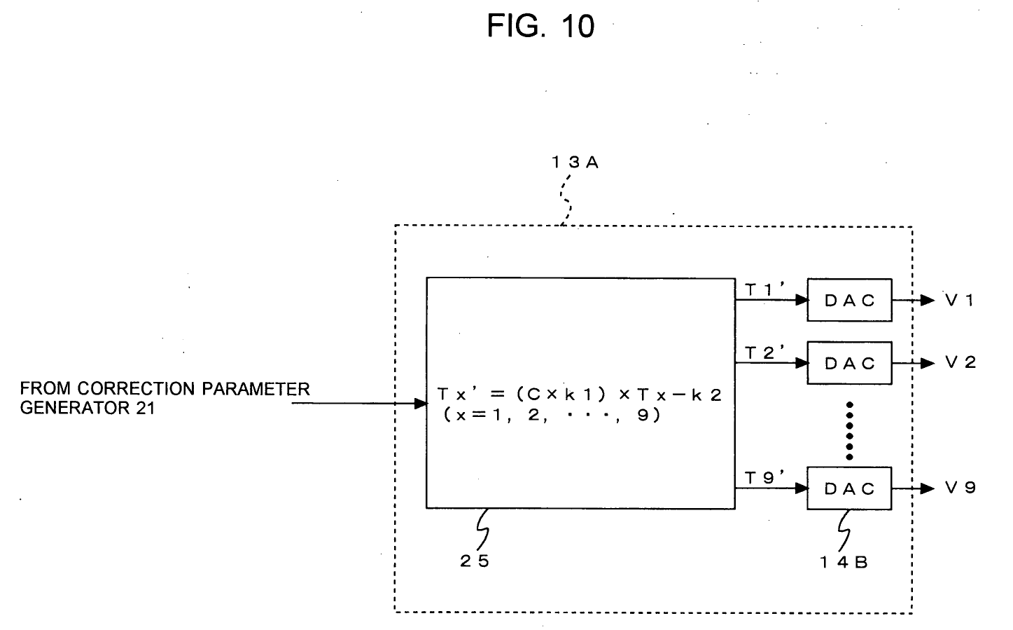

FIG. 10 is a block diagram showing an example of the construction of the reference gray-level signal generator 13A. As can be seen in FIG. 10, the reference gray-level signal generator 13A includes a reference gray-level signal operation unit 25 and a plurality of DACs 14B. The reference gray-level signal operation unit 25 performs an operation for the aforementioned contrast correction with respect to each reference gray level. The operation can be represented by the following Expression 1:

Tx′=(C×k1)×Tx−k2 (x=1, 2, . . . , 9) 1

where Tx is a reference gray level, Tx′ is a gray level obtained by the operation, and C, k1 and k2 are parameters sent from the correction parameter generator 21. A reference gray-level voltage is generated based on the output value Tx′. Each of the DACs 14B outputs an analog voltage corresponding to the digital value of Tx′. The DACs 14B possesses the same correction characteristics as shown in FIG. 3. The output analog voltage is sent to the DAC 14 as a reference voltage. Thereby, digital signals output from the image processing unit 11 undergo contrast correction in the DAC 14 while maintaining the dynamic range, and an image is displayed on the LCD screen 12.

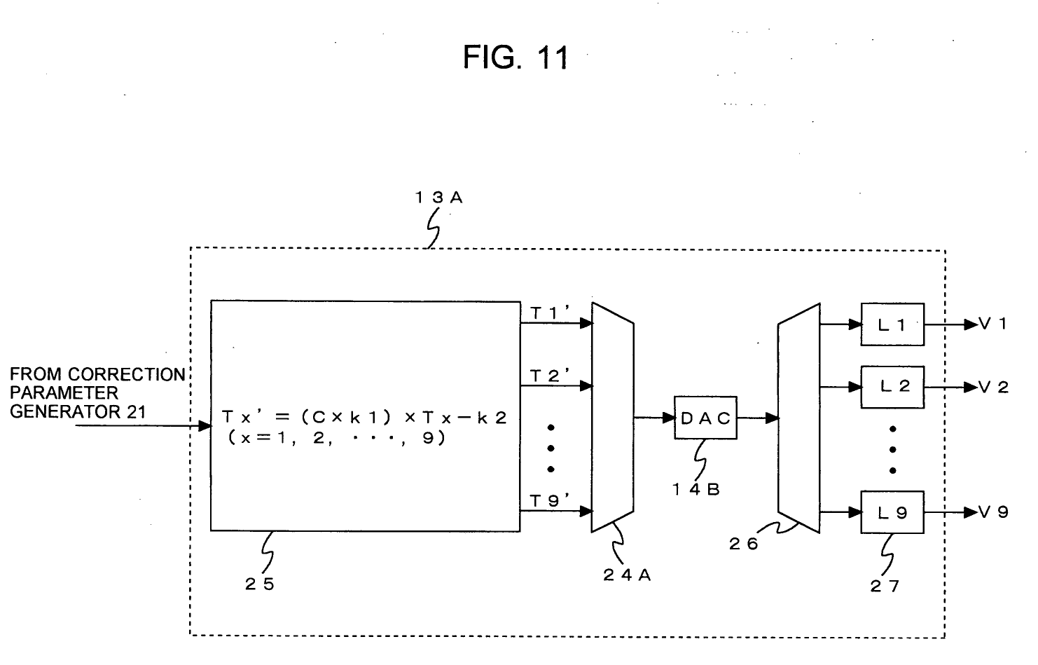

FIG. 11 is a block diagram showing another example of the construction of the reference gray-level signal generator 13A. The reference gray-level signal generator 13A in FIG. 11 has smaller circuitry, and includes a single DAC 14B, a selector 24A, a demultiplexer 26, and a plurality of voltage holding circuits 27 differently from that shown in FIG. 10.

In the reference gray-level signal generator 13A shown in FIG. 11, when T1′ is selected by the selector 24A and the demultiplexer 26, the output of the DAC 14B is held in L1 of the voltage holding circuits 27. Similarly, when T2′ is selected, the output of the DAC 14B is held in L2. That is, when Tn′ is selected, the output of the DAC 14B is held in Ln.

With this construction, it is possible to reduce the number of the DAC 14B which is large in circuitry scale while maintaining the same functions as those of the reference gray-level signal generator shown in FIG. 10.

As described above, the reference gray-level signal generator 13A changes the reference voltage so as to perform processing equivalent to contrast correction for digital image signals. Consequently, the operation in the image processing unit 11 is simplified, and the accumulation of quantization errors can be suppressed. Thus, it is possible to obtain the LCD making maximum use of the output dynamic range of the DAC 14.

Fourth Embodiment

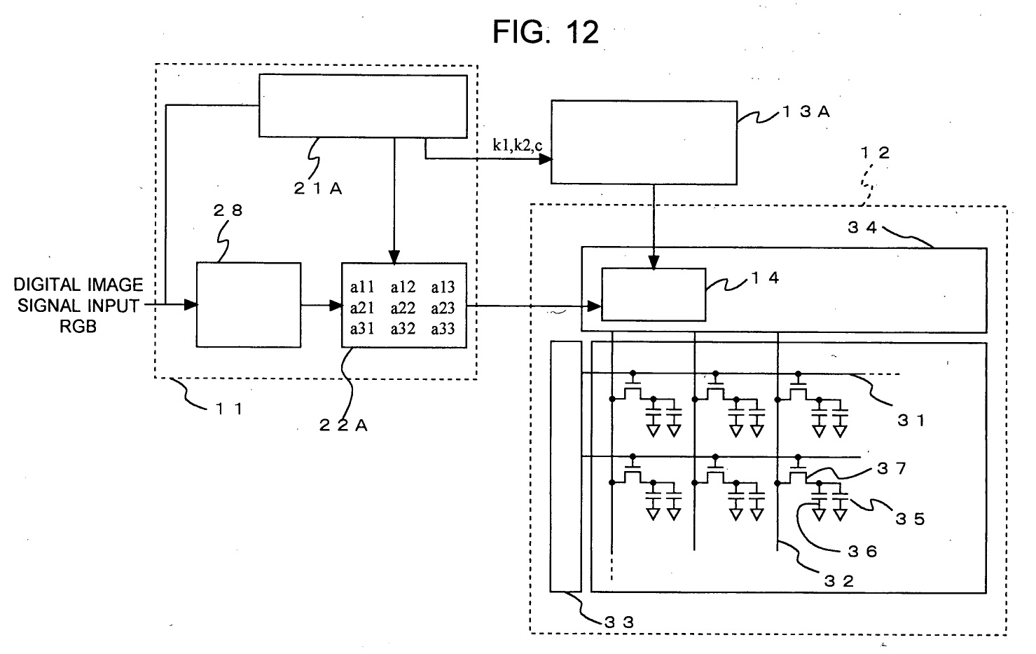

FIG. 12 is a block diagram showing the construction of an LCD according to the fourth embodiment of the present invention. In this embodiment, the LCD is provided with a frame buffer 28 at a stage before the 3×3 matrix converter 22A in the image processing unit 11, and a digital image signal input RGB is input to a correction parameter generator 21A differently from that of the third embodiment.

The LCD of the fourth embodiment differs from those of the above-described first to third embodiments in that input image signals are fed into the correction parameter generator 21A in order to generate parameters for contrast correction. By virtue of this construction, appropriate image processing and a reference gray-level voltage can be selected according to the luminance distribution in a moving image.

In the following the correction parameter generator 21A will be described in detail.

For example, it is assumed that A=0.9, B=0.1, and C=1 are set as matrix parameters, and that there is input a dark image with the maximum intensity level corresponding to 50% of the intensity level of “white” display and the minimum intensity level corresponding to 0% of the intensity level of “white” display (i.e. “black”). On this occasion, the correction parameter generator 21A may determine a correction parameter through the following two approaches:

(1) to display the image while maintaining the maximum intensity level in a frame; or

(2) to display the image with enhanced sharpness by increasing the maximum intensity level in a frame by contrast correction.

In the case of approach (1), contrast correction is not performed. Nevertheless, such effect as to suppress the occurrence of quantization errors is achieved. Therefore, approach (1) will be described.

According to approach (1), the operation performed by the reference gray-level signal generator 13A is expressed as follows:

k1=0.5−0=0.5

since the maximum intensity level in one frame is at 50% and the minimum intensity level is at 0% of the intensity level of “white” display. In addition, the reference gray-level signal operation unit 25 in the reference gray-level signal generator 13A performs the following operation based on Expression 1:

Tx′=(C×k1)×Tx−k2=0.5Tx

where k2=0 because the minimum intensity level represents “black”, and C=1. Thus, the reference gray-level signal generator 13A generates reference gray-level voltages V1 to V9.

On the other hand, matrix elements axy to be sent to the 3×3 matrix converter 22A are subject to multiplication by 1/(C/×k1), which is the inverse of multiplication by C×k1 performed by the reference gray-level signal generator 13A. That is, the matrix parameters sent to the 3×3 matrix converter 22A are expressed as follows:

a11=a22=a33=A/(C×k1)=0.9/(1×0.5)=1.8

a12=a23=a31=B/(C×k1)=0.1/(1×0.5)=0.2

a13=a21=a32=0/(C×k1)=0

With this construction, the accumulation of quantization errors in the image processing unit 11 can be suppressed while making maximum use of the dynamic range of the DAC 14. Thereby, it is possible to obtain the LCD capable of curbing the generation of pseudo outlines and noise caused by quantization errors.

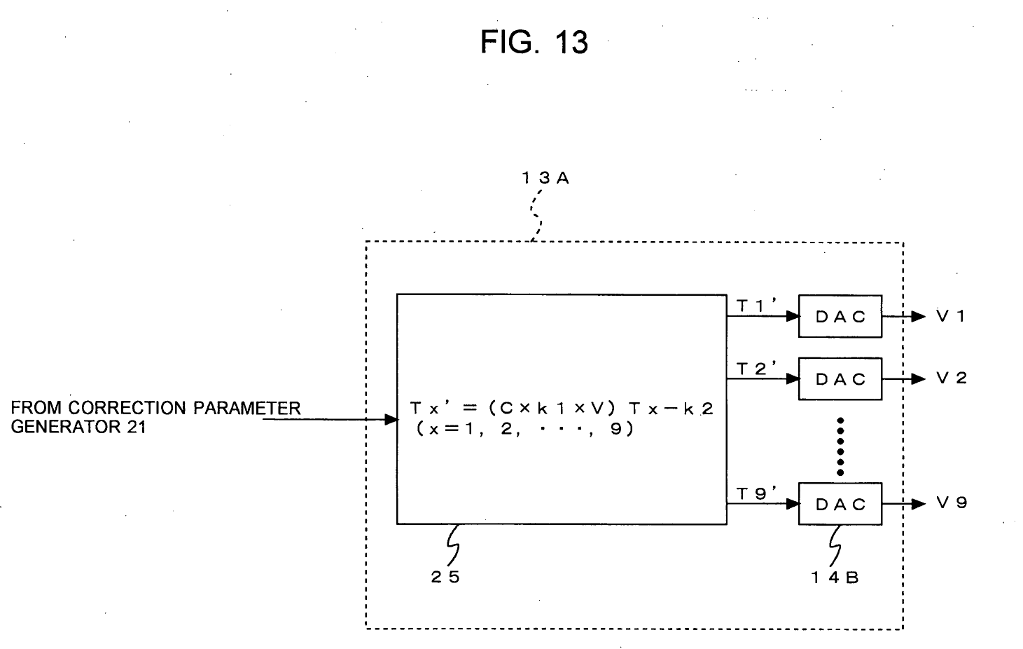

FIG. 13 is a block diagram showing an example of the construction of the reference gray-level signal generator 13A. With reference to FIG. 13, a description will be given of approach (2) for making contrast correction to multiply the maximum intensity level by 1.4, that is, convert 50% intensity into 70%, by way of example.

In the case of approach (2), the reference gray-level signal operation unit 25 performs the different operation than that of approach (1), which can be represented by the following Expression 2:

Tx′=(C×k1×V)×Tx−k2 2

where V is a contrast correction value, and in this example, V=1.4. If Expression 2 is rearranged by substituting 1.4 for V, then it becomes as follows:

Tx′=0.7Tx

Thereby, in addition to the effects achieved through approach (1) (reduction in accumulative quantization errors), it is possible to suppress the occurrence of quantization errors caused by multiplication in image processing, and to make contrast correction with a simple construction.

The maximum intensity level as well as input image signals varies frame to frame. In this embodiment, the correction parameter generator 21A generates each parameter once in a period of 1 frame. Preferably, a parameter is generated during a period in which the displaying of image is not carried out, for example, during the blanking interval of the LCD screen 12.

Incidentally, the image processing unit 11 is provided with the frame buffer 28 in order that each parameter generated by the correction parameter generator 21A can be applied to an appropriate frame image. In the case where the image processing unit 11 has no frame buffer, the application of each correction parameter is delayed by 1 frame. However, if this does not produce any problem on the occasion of image display, the frame buffer 28 may be omitted with the same advantages.

Fifth Embodiment

In the aforementioned fourth embodiment, an image is displayed on the basis that the contrast correction value V remains constant. This indicates that contrast correction is static.

In this embodiment, meanwhile, the contrast correction value V is determined dynamically according to input digital image signals so as to obtain the optimum quantity of contrast correction at any time.

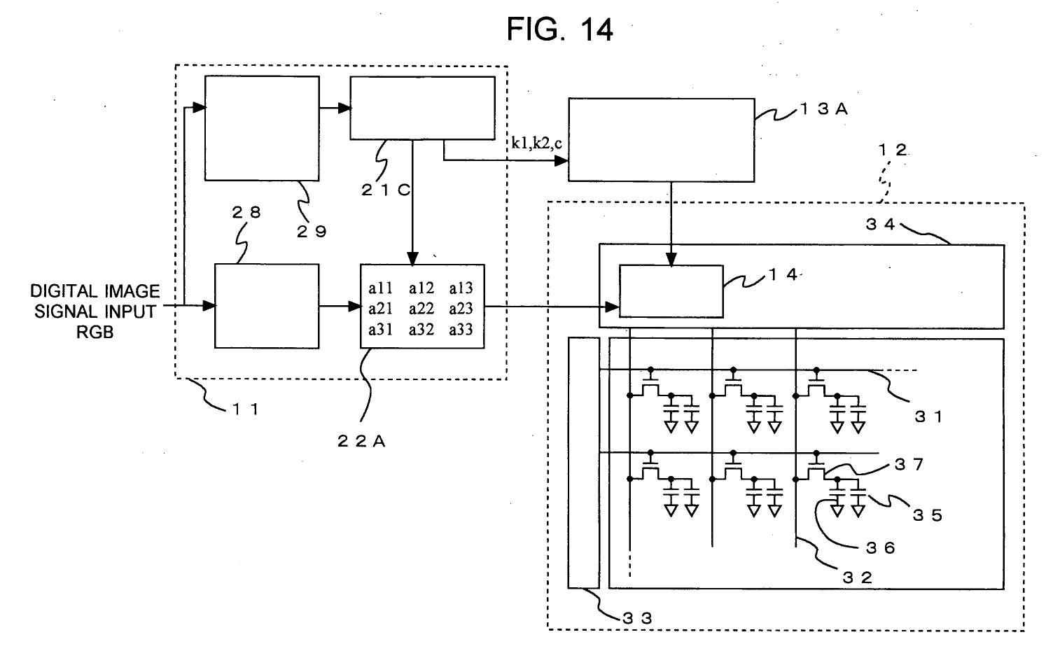

FIG. 14 is a block diagram showing the construction of an LCD according to the fifth embodiment of the present invention. As can be seen in FIG. 14, the LCD of the fifth embodiment further includes an image histogram generator 29 at a stage before a correction parameter generator 21C in the image processing unit 11 differently from that of the fourth embodiment.

In the following, the image histogram generator 29 and the correction parameter generator 21C will be described in detail.

The image histogram generator 29 generates an RGB histogram and an intensity level histogram based on input digital image signals for one frame. The image histogram generator 29 feeds the correction parameter generator 21C with these histograms. The correction parameter generator 21C sets a contrast correction value V based on the RGB histogram and the intensity level histogram according to the following procedure:

(a) hold a contrast correction value Vpast for the last frame;

(b) obtain a new contrast correction value Vpresent based on the intensity level histogram; and

(c) check if there is a sudden change in scenes, and set the Vpresent as a new contrast correction value V when a sudden change is detected or set the Vpast as a new contrast correction value V when no sudden change is detected.

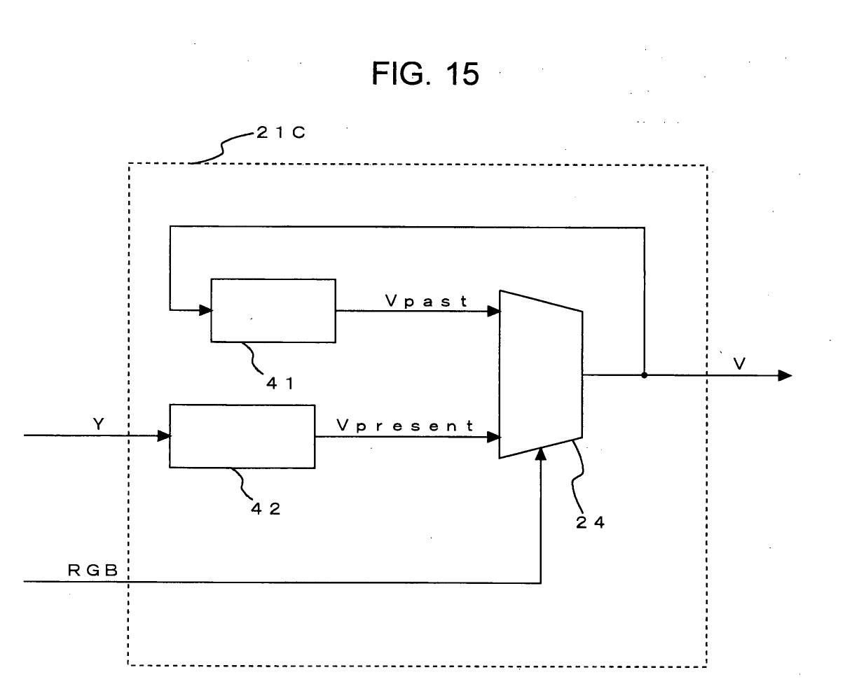

FIG. 15 is a diagram showing a construction for carrying out the above procedure. Referring to FIG. 15, the correction parameter generator 21C includes the selector 24, a register 41 and a contrast correction value operation unit 42. Procedural step (a) is implemented by the register 41 that holds the Vpast.

Procedural step (b) is realizable in various ways. For example, the Vpresent is obtained based on the maximum intensity level Ymax in a frame as in the fourth embodiment. Incidentally, Vpresent=2/(1+Ymax) so that the operation does not result in extreme contrast correction. Thereby, a contrast correction value of up to twice as high is determined dynamically according to input images.

Procedural step (c) for checking if there is a sudden change in scenes is important on the occasion of dynamic contrast correction. By detecting a sudden change in scenes, it is possible to suppress variation of the maximum intensity level in the same scene and the brightness of the entire image.

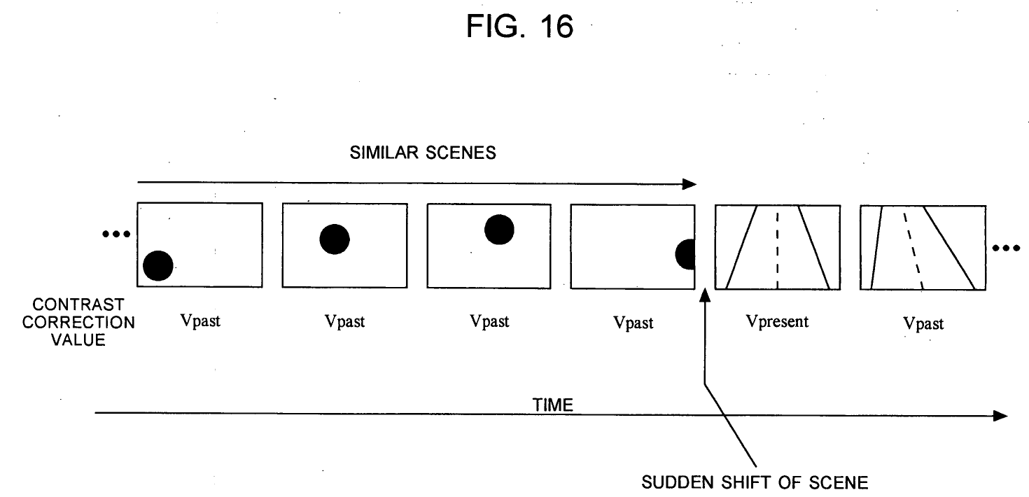

FIG. 16 is a diagram showing an example of timing in changing contrast correction quantity setting. When checking if there is a sudden change in scenes with respect to each frame (a sudden change in two successive frames), in the case where there is a substantial shift of scene, the contrast correction quantity is set/changed based on the intensity level histogram. FIG. 16 also shows which of the two, Vpresent and Vpast, is applied to each frame. As can be seen in FIG. 16, the Vpresent is applied only when there is a substantial shift of scene so as not to cause considerable variation in contrast among similar scenes.

Incidentally, as to the methods of detecting a change in scenes, a method as detecting the difference between image frames, a method as detecting the difference between the RGB histograms of input signals and determining that there is a shift of scene when the sum of the differences exceeds a specified value, and the like are applicable.

By virtue of this construction, the present invention can be applied to dynamic contrast correction.

Incidentally, in the above-described first to fifth embodiments, the function of the DAC 14 for converting digital image signals into analog voltages may be provided with respect to each color component of R, G and B signals. Besides, in the case where R, G and B signals are input temporally in series, the DAC 14 may switch its processing objects according to which color component of the R, G and B signals has been input.

Further, it is also possible that the DAC 14 uses the same reference gray-level voltage with respect to each color component of R, G and B signals.

Sixth Embodiment

While the present invention is applied to an LCD in the aforementioned first to fifth embodiments, the present invention is also applicable to an image processing apparatus. More specifically, the present invention can be applied to an image processing apparatus comprising the image processing unit which is a main constituent of the present invention, the DAC for converting digital image signals into voltages or current values, and a control unit for controlling reference signals for the DAC.

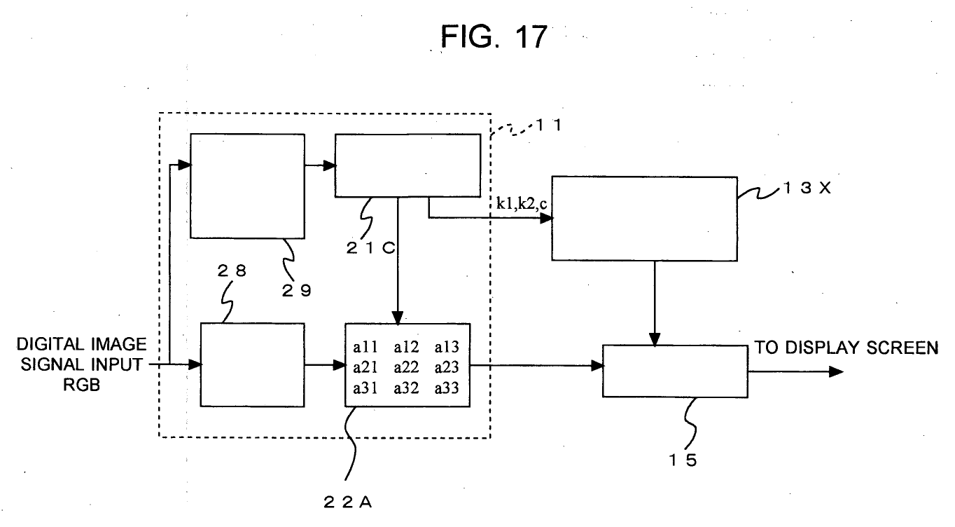

FIG. 17 is a block diagram showing the construction of an image processing apparatus according to the sixth embodiment of the present invention. Referring to FIG. 17, the image processing apparatus comprises the same image processing unit 11 as described previously for the LCD of the fifth embodiment, a reference gray-level signal generator 13X and an image signal converter 15.

As can be seen in FIG. 17, the image processing unit 11 is of the same construction as that of the fifth embodiment. This means that this embodiment enables the application of the reference gray-level signal generator 13A and the DAC 14 of the fifth embodiment to displays in general other than LCDs.

In the following, the reference gray-level signal generator 13X and the image signal converter 15 will be described in detail.

The LCD as shown in FIG. 14 is a hold-type display in which each pixel is driven by an analog voltage and holds the analog voltage for a period of 1 frame. Therefore, the DAC 14 converts digital signals into signals to be written on respective pixels of the display. Besides, the reference gray-level signal generator 13A generates reference gray-level voltages. In other words, the reference gray-level signal generator 13A and the DAC 14 are constituents peculiar to LCDs.

On the other hand, the reference gray-level signal generator 13X and the image signal converter 15 each have a construction so as to be applicable to various displays other than LCDs. For example, in a current-steered or current-driving type electroluminescence display (ELD), current and the gray level of each pixel are substantially in proportionality relation with each other, and it is required to convert digital image signals into current values. Consequently, in the ELD, the image signal converter 15 converts digital image signals into current values, and the reference gray-level signal generator 13×generates current values of reference for the conversion.

Further, in a pulse-width modulation (PWM) plasma display panel (PDP), the image signal converter 15 sets one of pulses each having a different width to turn on according to an input digital image signal value, and the reference gray-level signal generator 13X changes the pulse width.

As is described above, the image processing apparatus of the sixth embodiment is provided with the image processing unit 11, the reference gray-level signal generator 13X and the image signal converter 15 which can be applied to displays in general. Therefore, according to the sixth embodiment, the present invention becomes applicable to a variety of displays with the same advantages as described for the LCDs of the first to fifth embodiments regardless of display type.

While the sixth embodiment of the present invention has been described as applied to the ELD and PDP, the ELD and PDP are cited merely by way of example and without limitation. It would be obvious that the present invention may be applied to projector LCDs, PWM projector LCDs and the like.

Seventh Embodiment

While in the sixth embodiment, there is provided the image processing apparatus which can be applied to displays in general regardless of their types, the functions of the image processing unit may be implemented through software on a computer. In this embodiment, a description will be given of an image processing method for realizing the functions of the image processing unit by software on a computer.

Incidentally, the image processing unit operates in the same manner as described previously in the first to sixth embodiments, and the specific contents of its processing will not be described. In the following, a description will be given in detail of only the construction of functional blocks implemented on a computer for performing the processing.

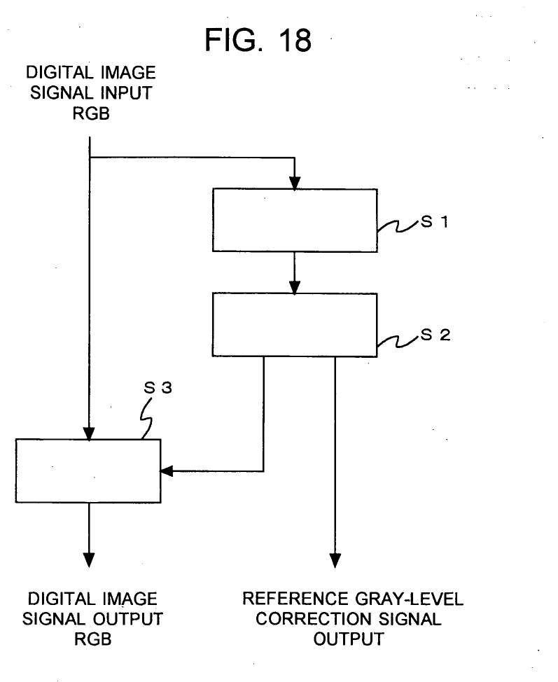

FIG. 18 is a diagram showing functional blocks implemented on a computer by software for carrying out image processing and signals input/output to/from the respective blocks according to the seventh embodiment of the present invention. First, an RGB histogram and an intensity level histogram are generated according to image data for one frame at an image histogram generating block S1. On the basis of the histograms generated at the image histogram generating block S1, a correction parameter output to an image processing operation block S3 and a reference gray-level correction signal output to the external reference gray-level signal generator are generated at a correction parameter generating block S2. With reference to the correction parameter generated at the correction parameter generating block S2, a digital image processing operation is performed with respect to each input digital image (input digital image signal) at the image processing operation block S3.

The aforementioned functional blocks have functions equivalent to the functions of the image processing unit 11 as described previously for the first to sixth embodiments. With this construction, the operation of the image processing unit can be simplified, and there can be provided an image processing method for displays making the most use of the output dynamic range while suppressing the accumulation of quantization errors.

As set forth hereinabove, in accordance with the present invention, among a variety of image processing, processing which can be represented by look-up tables (LUT) such as constant number multiplication and constant number addition/subtraction is performed equivalently by changing reference values in the reference gray-level signal generator of the display. Thus, the operation of the image processing unit can be simplified, and there can be provided an LCD, an image processing apparatus and an image processing method making the most use of the output dynamic range while suppressing the occurrence and accumulation of quantization errors.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An LCD comprising:
an LCD screen for displaying an image based on input image signals;
a gray-level corrector for generating and outputting an analog gray-level voltage based on respective digital image signals so that an image according to the digital image signals is displayed on the LCD screen; and
a digital image processing unit for carrying out predetermined arithmetic operations for the digital image signals;
wherein prescribed image processing is performed for the digital image signals by changing corrective characteristics of the gray-level corrector.

2. The LCD claimed in claim 1, wherein the prescribed image processing is processing which is expressible as look-up tables, and each color component of the digital image signals before and after the processing is presented in the look-up table for the color component.

3. The LCD claimed in claim 1, wherein the prescribed image processing is processing which is expressible by a combination of constant number multiplication, constant number addition, constant number subtraction, and/or S-curve correction.

4. An LCD comprising:
an LCD screen for displaying an image based on input image signals;
a gray-level corrector for generating and outputting an analog 5 gray-level voltage based on respective digital image signals so that an image according to the digital image signals is displayed on the LCD screen;
a digital image processing unit for carrying out predetermined arithmetic operations for the digital image signals; and
a correction parameter generator for generating correction parameters used for the arithmetic operations by the digital image processing unit;
wherein the correction parameter generator feeds the gray-level corrector with the correction parameters so that prescribed image processing is to be performed based on the correction parameters.

5. The LCD claimed in claim 4, wherein the prescribed image processing is processing which is expressible as look-up tables, and each color component of the digital image signals before and after the processing is presented in the look-up table for the color component.

6. The LCD claimed in claim 4, wherein the prescribed image processing is processing which is expressible by a combination of constant number multiplication, constant number addition, constant number subtraction, and/or S-curve correction.

7. An LCD comprising:
an LCD screen for displaying an image based on input image signals;
a gray-level corrector for generating and outputting an analog gray-level voltage based on respective digital image signals so that an image according to the digital image signals is displayed on the LCD screen;
a digital image processing unit for carrying out predetermined arithmetic operations for the digital image signals; and
a correction parameter generator for generating correction parameters used for the arithmetic operations by the digital image processing unit;
wherein the correction parameter generator feeds the gray-level corrector with the generated correction parameters.

8. The LCD claimed in claim 4, wherein the correction parameter generator determines the correction parameter based on input digital image signals.

9. The LCD claimed in claim 5, wherein the correction parameter generator determines the correction parameter based on input digital image signals.

10. The LCD claimed in claim 6, wherein the correction parameter generator determines the correction parameter based on input digital image signals.

11. The LCD claimed in claim 7, wherein the correction parameter generator determines the correction parameter based on input digital image signals.

12. The LCD claimed in claim 4, wherein the correction parameter generator determines the correction parameter based on a histogram for the input digital image signals of one frame.

13. The LCD claimed in claim 5, wherein the correction parameter generator determines the correction parameter based on a histogram for the input digital image signals of one frame.

14. The LCD claimed in claim 6, wherein the correction parameter generator determines the correction parameter based on a histogram for the input digital image signals of one frame.

15. The LCD claimed in claim 7, wherein the correction parameter generator determines the correction parameter based on a histogram for the input digital image signals of one frame.

16. The LCD claimed in claim 4, wherein the correction parameter generator generates the correction parameter in the case where an image according to the digital image signals changes more than a specific quantity.

17. The LCD claimed in claim 5, wherein the correction parameter generator generates the correction parameter in the case where an image according to the digital image signals changes more than a specific quantity.

18. The LCD claimed in claim 6, wherein the correction parameter generator generates the correction parameter in the case where an image according to the digital image signals changes more than a specific quantity.

19. The LCD claimed in claim 7, wherein the correction parameter generator generates the correction parameter in the case where an image according to the digital image signals changes more than a specific quantity.

20. The LCD claimed in claim 4, wherein the correction parameter generator generates the correction parameter based on input digital image signals in the case where an image according to the digital image signals changes more than a specific quantity.

21. The LCD claimed in claim 5, wherein the correction parameter generator generates the correction parameter based on input digital image signals in the case where an image according to the digital image signals changes more than a specific quantity.

22. The LCD claimed in claim 6, wherein the correction parameter generator generates the correction parameter based on input digital image signals in the case where an image according to the digital image signals changes more than a specific quantity.

23. The LCD claimed in claim 7, wherein the correction parameter generator generates the correction parameter based on input digital image signals in the case where an image according to the digital image signals changes more than a specific quantity.

24. The LCD claimed in claim 4, wherein the correction parameter generator generates the correction parameter based on a histogram for the input digital image signals of one frame in the case where an image according to the digital image signals changes more than a specific quantity.

25. The LCD claimed in claim 5, wherein the correction parameter generator generates the correction parameter based on a histogram for the input digital image signals of one frame in the case where an image according to the digital image signals changes more than a specific quantity.

26. The LCD claimed in claim 6, wherein the correction parameter generator generates the correction parameter based on a histogram for the input digital image signals of one frame in the case where an image according to the digital image signals changes more than a specific quantity.

27. The LCD claimed in claim 7, wherein the correction parameter generator generates the correction parameter based on a histogram for the input digital image signals of one frame in the case where an image according to the digital image signals changes more than a specific quantity.

28. The LCD claimed in claim 1, wherein:
the gray-level corrector includes a first DAC for converting the digital image signal into an analog voltage, and a reference gray-level voltage generator for setting a gray-level characteristic based on the relation between the input voltage and display intensity of the LCD screen; and
the reference gray-level voltage is changed based on a correction parameter.

29. The LCD claimed in claim 2, wherein:
the gray-level corrector includes a first DAC for converting the digital image signal into an analog voltage, and a reference gray-level voltage generator for setting a gray-level characteristic based on the relation between the input voltage and display intensity of the LCD screen; and
the reference gray-level voltage is changed based on a correction parameter.

30. The LCD claimed in claim 3, wherein:
the gray-level corrector includes a first DAC for converting the digital image signal into an analog voltage, and a reference gray-level voltage generator for setting a gray-level characteristic based on the relation between the input voltage and display intensity of the LCD screen; and
the reference gray-level voltage is changed based on a correction parameter.

31. The LCD claimed in claim 4, wherein:
the gray-level corrector includes a first DAC for converting the digital image signal into an analog voltage, and a reference gray-level voltage generator for setting a gray-level characteristic based on the relation between the input voltage and display intensity of the LCD screen; and
the reference gray-level voltage is changed based on the correction parameter.

32. The LCD claimed in claim 5, wherein:
the gray-level corrector includes a first DAC for converting the digital image signal into an analog voltage, and a reference gray-level voltage generator for setting a gray-level characteristic based on the relation between the input voltage and display intensity of the LCD screen; and
the reference gray-level voltage is changed based on the correction parameter.

33. The LCD claimed in claim 6, wherein:
the gray-level corrector includes a first DAC for converting the digital image signal into an analog voltage, and a reference gray-level voltage generator for setting a gray-level characteristic based on the relation between the input voltage and display intensity of the LCD screen; and
the reference gray-level voltage is changed based on the correction parameter.

34. The LCD claimed in claim 7, wherein:
the gray-level corrector includes a first DAC for converting the digital image signal into an analog voltage, and a reference gray-level voltage generator for setting a gray-level characteristic based on the relation between the input voltage and display intensity of the LCD screen; and
the reference gray-level voltage is changed based on the correction parameter.

35. The LCD claimed in claim 8, wherein:
the gray-level corrector includes a first DAC for converting the digital image signal into an analog voltage, and a reference gray-level voltage generator for setting a gray-level characteristic based on the relation between the input voltage and display intensity of the LCD screen; and
the reference gray-level voltage is changed based on the correction parameter.

36. The LCD claimed in claim 11, wherein:
the gray-level corrector includes a first DAC for converting the digital image signal into an analog voltage, and a reference gray-level voltage generator for setting a gray-level characteristic based on the relation between the input voltage and display intensity of the LCD screen; and
the reference gray-level voltage is changed based on the correction parameter.

37. The LCD claimed in claim 12, wherein:
the gray-level corrector includes a first DAC for converting the digital image signal into an analog voltage, and a reference gray-level voltage generator for setting a gray-level characteristic based on the relation between the input voltage and display intensity of the LCD screen; and
the reference gray-level voltage is changed based on the correction parameter.

38. The LCD claimed in claim 15, wherein:
the gray-level corrector includes a first DAC for converting the digital image signal into an analog voltage, and a reference gray-level voltage generator for setting a gray-level characteristic based on the relation between the input voltage and display intensity of the LCD screen; and
the reference gray-level voltage is changed based on the correction parameter.

39. The LCD claimed in claim 16, wherein:
the gray-level corrector includes a first DAC for converting the digital image signal into an analog voltage, and a reference gray-level voltage generator for setting a gray-level characteristic based on the relation between the input voltage and display intensity of the LCD screen; and
the reference gray-level voltage is changed based on the correction parameter.

40. The LCD claimed in claim 19, wherein:
the gray-level corrector includes a first DAC for converting the digital image signal into an analog voltage, and a reference gray-level voltage generator for setting a gray-level characteristic based on the relation between the input voltage and display intensity of the LCD screen; and
the reference gray-level voltage is changed based on the correction parameter.

41. The LCD claimed in claim 20, wherein:
the gray-level corrector includes a first DAC for converting the digital image signal into an analog voltage, and a reference gray-level voltage generator for setting a gray-level characteristic based on the relation between the input voltage and display intensity of the LCD screen; and
the reference gray-level voltage is changed based on the correction parameter.

42. The LCD claimed in claim 23, wherein:
the gray-level corrector includes a first DAC for converting the digital image signal into an analog voltage, and a reference gray-level voltage generator for setting a gray-level characteristic based on the relation between the input voltage and display intensity of the LCD screen; and
the reference gray-level voltage is changed based on the correction parameter.

43. The LCD claimed in claim 24, wherein:
the gray-level corrector includes a first DAC for converting the digital image signal into an analog voltage, and a reference gray-level voltage generator for setting a gray-level characteristic based on the relation between the input voltage and display intensity of the LCD screen; and
the reference gray-level voltage is changed based on the correction parameter.

44. The LCD claimed in claim 27, wherein:
the gray-level corrector includes a first DAC for converting the digital image signal into an analog voltage, and a reference gray-level voltage generator for setting a gray-level characteristic based on the relation between the input voltage and display intensity of the LCD screen; and
the reference gray-level voltage is changed based on the correction parameter.

45. The LCD claimed in claim 1, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC; and
the reference gray-level voltage is changed based on a correction parameter.

46. The LCD claimed in claim 2, wherein:
the gray-level corrector includes a first DAC for converting the digital image signal into an analog voltage, and a reference gray-level voltage generator for setting a gray-level characteristic based on the relation between the input voltage and display intensity of the LpD screen;
the reference gray-level voltage generator includes a second DAC having the same gray-level characteristic as that of the first DAC; and
the reference gray-level voltage is changed based on a correction parameter.

47. The LCD claimed in claim 3, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC; and
the reference gray-level voltage is changed based on a correction parameter.

48. The LCD claimed in claim 4, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC; and
the reference gray-level voltage is changed based on the correction parameter.

49. The LCD claimed in claim 5, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC; and
the reference gray-level voltage is changed based on the correction parameter.

50. The LCD claimed in claim 6, Wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC; and
the reference gray-level voltage is changed based on the correction parameter.

51. The LCD claimed in claim 7, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC; and
the reference gray-level voltage is changed based on the correction parameter.

52. The LCD claimed in claim 8, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC; and
the reference gray-level voltage is changed based on the correction parameter.

53. The LCD claimed in claim 11, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC; and
the reference gray-level voltage is changed based on the correction parameter.

54. The LCD claimed in claim 12, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC; and
the reference gray-level voltage is changed based on the correction parameter.

55. The LCD claimed in claim 15, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC; and
the reference gray-level voltage is changed based on the correction parameter.

56. The LCD claimed in claim 16, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC; and
the reference gray-level voltage is changed based on the correction parameter.

57. The LCD claimed in claim 19, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC; and
the reference gray-level voltage is changed based on the correction parameter.

58. The LCD claimed in claim 20, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC; and
the reference gray-level voltage is changed based on the correction parameter.

59. The LCD claimed in claim 23, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC; and
the reference gray-level voltage is changed based on the correction parameter.

60. The LCD claimed in claim 24, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC; and
the reference gray-level voltage is changed based on the correction parameter.

61. The LCD claimed in claim 27, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC; and
the reference gray-level voltage is changed based on the correction parameter.

62. The LCD claimed in claim 1, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC, and a means for selecting the reference gray-level voltage based on a correction parameter; and
the reference gray-level voltage is changed based on the correction parameter.

63. The LCD claimed in claim 2, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC, and a means for selecting the reference gray-level voltage based on a correction parameter; and
the reference gray-level voltage is changed based on the correction parameter.

64. The LCD claimed in claim 3, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC, and a means for selecting the reference gray-level voltage based on a correction parameter; and
the reference gray-level voltage is changed based on the correction parameter.

65. The LCD claimed in claim 4, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC, and a means for selecting the reference gray-level voltage based on the correction parameter; and
the reference gray-level voltage is changed based on the correction parameter.

66. The LCD claimed in claim 5, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC, and a means for selecting the reference gray-level voltage based on the correction parameter; and
the reference gray-level voltage is changed based on the correction parameter.

67. The LCD claimed in claim 6, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC, and a means for selecting the reference gray-level voltage based on the correction parameter; and
the reference gray-level voltage is changed based on the correction parameter.

68. The LCD claimed in claim 7, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC, and a means for selecting the reference gray-level voltage based on the correction parameter; and
the reference gray-level voltage is changed based on the correction parameter.

69. The LCD claimed in claim 8, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC, and a means for selecting the reference gray-level voltage based on the correction parameter; and
the reference gray-level voltage is changed based on the correction parameter.

70. The LCD claimed in claim 11, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC, and a means for selecting the reference gray-level voltage based on the correction parameter; and
the reference gray-level voltage is changed based on the correction parameter.

71. The LCD claimed in claim 12, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC, and a means for selecting the reference gray-level voltage based on the correction parameter; and
the reference gray-level voltage is changed based on the correction parameter.

72. The LCD claimed in claim 15, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC, and a means for selecting the reference gray-level voltage based on the correction parameter; and
the reference gray-level voltage is changed based on the correction parameter.

73. The LCD claimed in claim 16, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC, and a means for selecting the reference gray-level voltage based on the correction parameter; and
the reference gray-level voltage is changed based on the correction parameter.

74. The LCD claimed in claim 19, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC, and a means for selecting the reference gray-level voltage based on the correction parameter; and
the reference gray-level voltage is changed based on the correction parameter.

75. The LCD claimed in claim 20, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC, and a means for selecting the reference gray-level voltage based on the correction parameter; and
the reference gray-level voltage is changed based on the correction parameter.

76. The LCD claimed in claim 23, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC, and a means for selecting the reference gray-level voltage based on the correction parameter; and
the reference gray-level voltage is changed based on the correction parameter.

77. The LCD claimed in claim 24, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC, and a means for selecting the reference gray-level voltage based on the correction parameter; and
the reference gray-level voltage is changed based on the correction parameter.

78. The LCD claimed in claim 27, wherein:
the gray-level corrector includes a first DAC for converting the digital image signal into an analog voltage, and a reference gray-level voltage generator for setting a gray-level characteristic based on the relation between the input voltage and display intensity of the LCD screen;
the reference gray-level voltage generator includes a second DAC having the same gray-level characteristic as that of the first DAC, and a means for selecting the reference gray-level voltage based on the correction parameter; and
the reference gray-level voltage is changed based on the correction parameter.

79. An image processing apparatus comprising:
a digital image processing unit for carrying out predetermined arithmetic operations for digital image signals; and
an image signal converter for converting the digital image signal which has undergone the arithmetic operation into a signal used to apply a voltage to a pixel of an LCD screen;
wherein prescribed image processing is performed for the digital image signals by changing signal conversion characteristics of the image signal converter.

80. An image processing apparatus comprising:
a digital image processing unit for carrying out predetermined arithmetic operations for digital image signals;
an image signal converter for converting the digital image signal which has undergone the arithmetic operation into a signal used to apply a voltage to a pixel of an LCD screen; and
a correction parameter generator for generating correction parameters used for the arithmetic operations by the digital image processing unit;
wherein the correction parameter generator feeds the image signal converter with the generated correction parameters.

81. An image processing apparatus comprising:
a digital image processing unit for carrying out predetermined arithmetic operations for digital image signals;
an image signal converter for converting the digital image signal which has undergone the arithmetic operation into a signal used to apply a voltage to a pixel of an LCD screen; and
a correction parameter generator for generating correction parameters used for the arithmetic operations by the digital image processing unit;
wherein the correction parameter generator feeds the image signal converter with the correction parameters so that prescribed image processing is to be performed based on the correction parameters.

82. The image processing apparatus claimed in claim 80, wherein the correction parameter generator determines the correction parameter based on input digital image signals.

83. The image processing apparatus claimed in claim 81, wherein the correction parameter generator determines the correction parameter based on input digital image signals.

84. The image processing apparatus claimed in claim 80, wherein the correction parameter generator determines the correction parameter based on a histogram for the input digital image signals of one frame.

85. The image processing apparatus claimed in claim 81, wherein the correction parameter generator determines the correction parameter based on a histogram for the input digital image signals of one frame.

86. The image processing apparatus claimed in claim 80, wherein the correction parameter generator generates the correction parameter in the case where an image according to the digital image signals changes more than a specific quantity.

87. The image processing apparatus claimed in claim 81, wherein the correction parameter generator generates the correction parameter in the case where an image according to the digital image signals changes more than a specific quantity.

88. The image processing apparatus claimed in claim 80, wherein the correction parameter generator generates the correction parameter based on input digital image signals in the case where an image according to the digital image signals changes more than a specific quantity.

89. The image processing apparatus claimed in claim 81, wherein the correction parameter generator generates the correction parameter based on input digital image signals in the case where an image according to the digital image signals changes more than a specific quantity.

90. The image processing apparatus claimed in claim 80, wherein the correction parameter generator generates the correction parameter based on a histogram for the input digital image signals of one frame in the case where an image according to the digital image signals changes more than a specific quantity.

91. The image processing apparatus claimed in claim 81, wherein the correction parameter generator generates the correction parameter based on a histogram for the input digital image signals of one frame in the case where an image according to the digital image signals changes more than a specific quantity.

92. An image processing method comprising:
a correction parameter generating step for generating a calculation parameter; and
a step for carrying out a predetermined arithmetic operation for each digital image signal by the use of the calculation parameter;
wherein a correction parameter for prescribed image processing is generated at the correction parameter generating step.
